(19) United States
(12) Patent Application Publication
(10) Pub. No.: US 2025/0133173 A1
(43) Pub. Date: Apr. 24, 2025

(54) IMAGE FORMING SYSTEM

(71) Applicant: CANON KABUSHIKI KAISHA, Tokyo (JP)

(72) Inventors: AYA TAKAGI, Shizuoka (JP); KAZUHIKO AONO, Shizuoka (JP)

(21) Appl. No.: 18/884,410

(22) Filed: Sep. 13, 2024

(30) Foreign Application Priority Data
Oct. 24, 2023 (JP) 2023-182879

(51) Int. Cl. H04N 1/00; G03G 15/00; G03G 21/16

(52) U.S. Cl. CPC H04N 1/00925; G03G 15/6508; G03G 21/1647; G03G 21/1652; H04N 1/00538; H04N 1/0083

(57) ABSTRACT

An image forming system includes an image forming apparatus; an option feeding device, wherein to a lower portion of the option feeding device, another option feeding device is connectable; an installation member; a controller; a communicating portion; an engaging portion; and an engagement detecting portion. On the basis of a communication result by the communicating means and a detection result by the engagement detecting means, the controller acquires first information on whether or not the installation member is connected to the image forming apparatus. On the basis of the communication result by the communicating means, the controller acquires second information on a number of the option feeding devices connected to the image forming apparatus. On the basis of the first information and the second information, the controller is capable of executing restricting processing for restricting image formation by the image forming apparatus.

### FIELD OF THE INVENTION AND RELATED ART

The present invention relates to an image forming system in which an option feeding device for feeding a sheet to an image forming apparatus is capable of being connected to the image forming apparatus.

Conventionally, for example, there is an image forming system constituted so that a plurality of option feeding devices for sheet feeding as an option device are capable of being stacked and mounted to a lower portion of an image forming apparatus using an electrophotographic type. This image forming system is constituted so that the sheet can be conveyed from the option feeding device to an image forming portion in the image forming apparatus through a sheet conveying path in the option feeding device and a sheet conveying path in the image forming apparatus. By additionally providing the option feeding devices to the image forming apparatus, sheets in a large amounts can be fed or sheets different in kinds can be selectively used.

A weight of the image forming apparatus is heavier than a weight of the option feeding devices, so that in the case where many option feeding devices are connected to the image forming apparatus, center of gravity of the image forming system becomes a high position. Further, when option feeding devices in number exceeding a predetermined number are connected to the image forming apparatus, even if there is no problem in a normal state, there arises a need to prevent falling of the image forming system in some instances in the case where a floor surface is largely vibrated, such as the case of earthquake or during movement or the like of the image forming apparatus.

In Japanese Laid-Open Patent Application (JP-A) 2022-117735, a constitution in which an operation of an image forming apparatus is restricted in the case where option feeding devices in number larger than a threshold set in advance depending on presence/absence of the option feeding devices of a type of floor surface installation for preventing fall of the image forming system has been proposed.

Thus, by restricting the operation of the image forming apparatus, an operator such as a user or a service person is prompted to check and recombine a constitution of the image forming system, so that an occurrence of a risk of falling of the image forming system can be prevented.

In the constitution disclosed in JP-A 2022-117735, the plurality of option feeding devices capable of being additionally connected to the image forming apparatus and the option feeding device of the type of the floor surface installation for preventing the falling are presence in mixture. Further, in this constitution, by using electrical contacts provided to each of the option feeding devices, presence/absence of the option feeding device for preventing the falling is discriminated.

### SUMMARY OF THE INVENTION

A principal object of the present invention is to provide an image forming system capable restricting image formation of the image forming apparatus on the basis of a result of discrimination of a system constitution.

This object is accomplished by an image forming system according to the present invention. According to an aspect of the present invention, there is provided an image forming system comprising: an image forming apparatus configured to form an image on a sheet; an option feeding device connected to a lower portion of the image forming apparatus and configured to feed the sheet to the image forming apparatus, wherein to a lower portion of the option feeding device, another option feeding device is connectable so that a plurality of option feeding devices are stacked in a vertical direction and are connectable; an installation member configured to be installed on a floor surface and connectable to a lower portion of the option feeding member; a controller configured to control an operation of the image forming apparatus; communicating means configured to transmit and receive a signal between the image forming apparatus and the option feeding device; an engaging portion provided to the option feeding device and configured to engage with the another option feeding device to be connected to the lower portion of the option feeding device or with the installation member; and engagement detecting means provided to the option feeding device and configured to detect engagement of the engaging portion with the another option feeding device to be connected to the lower portion of the option feeding device or with the installation member, wherein on the basis of a communication result by the communicating means and a detection result by the engagement detecting means, the controller acquires first information on whether or not the installation member is connected to the image forming apparatus, wherein on the basis of the communication result by the communicating means, the controller acquires second information on a number of the option feeding devices connected to the image forming apparatus, and wherein on the basis of the first information and the second information, the controller is capable of executing restricting processing for restricting image formation by the image forming apparatus.

Further features of the present invention will become apparent from the following description of exemplary embodiments with reference to the attached drawings.

### BRIEF DESCRIPTION OF THE DRAWINGS

FIG. 1 is a schematic sectional view of an image forming system.

Part (a) of FIG. 2 is a schematic view of an option feeding device, part (b) of FIG. 2 is a schematic plan view of a fall-preventing member, part (c) of FIG. 2 is a schematic sectional view of the option feeding device, and part (d) of FIG. 2 is a schematic sectional view of the fall-preventing member.

Part (a) of FIG. 3 is a schematic sectional view for illustrating engagement between an image forming apparatus and the option feeding device, part (b) of FIG. 3 is a schematic sectional view for illustrating engagement between the option feeding device and another option feeding device, and part (c) of FIG. 3 is a schematic sectional view for illustrating engagement between an option feeding device and a fall-preventing member.

FIG. 4 is a schematic block diagram showing a hardware constitution of the image forming system.

FIG. 5 is a schematic block diagram showing a functional constitution of the image forming system.

Parts (a) and (b) of FIG. 6 are schematic views for illustrating constitutions of a controller and an option controller, respectively.

FIG. 7 is a flowchart showing a procedure for discriminating a constitution of the image forming system.

FIG. 8 is a flowchart showing a procedure of presence/absence discriminating processing of the fall-preventing member in the procedure shown in FIG. 7.

FIG. 9 is a schematic view showing an example of display in a display operation panel.

FIG. 10 is a schematic sectional view of an image forming system according to another embodiment.

### DESCRIPTION OF THE EMBODIMENTS

In the following, an image forming system according to the present invention will be further described specifically with reference to the drawings.

### Embodiment 1

### <General Constitution and Operation of Image Forming System>

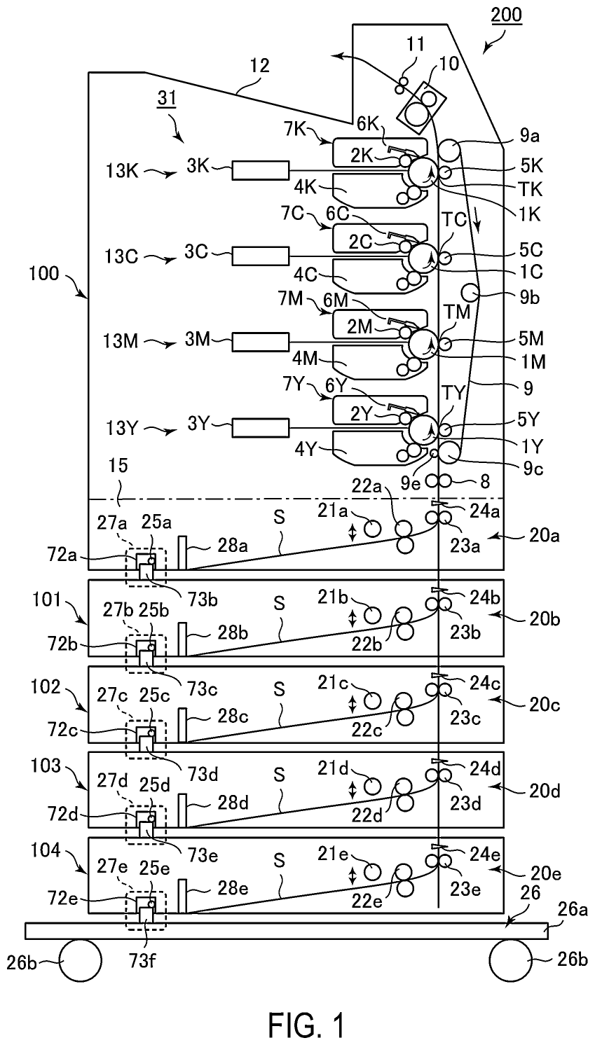

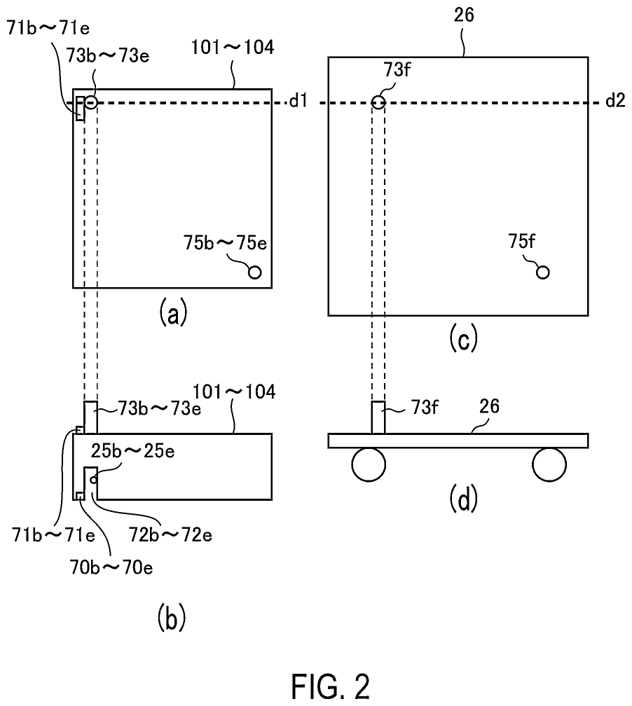

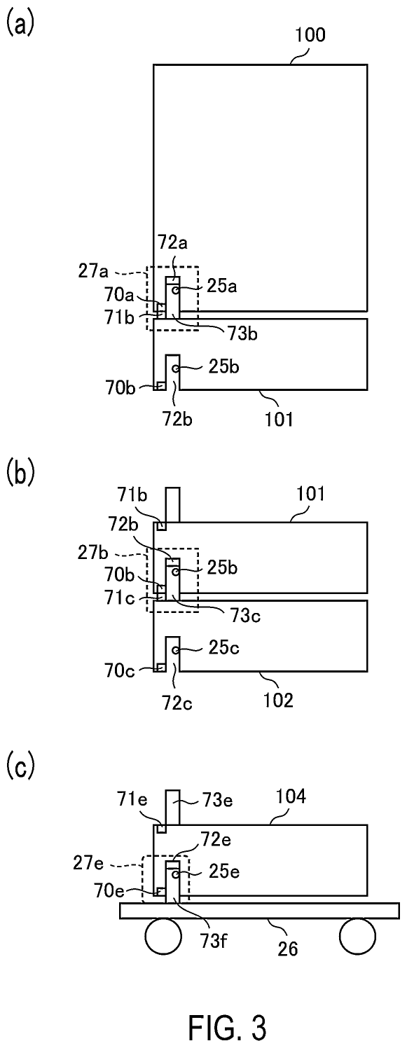

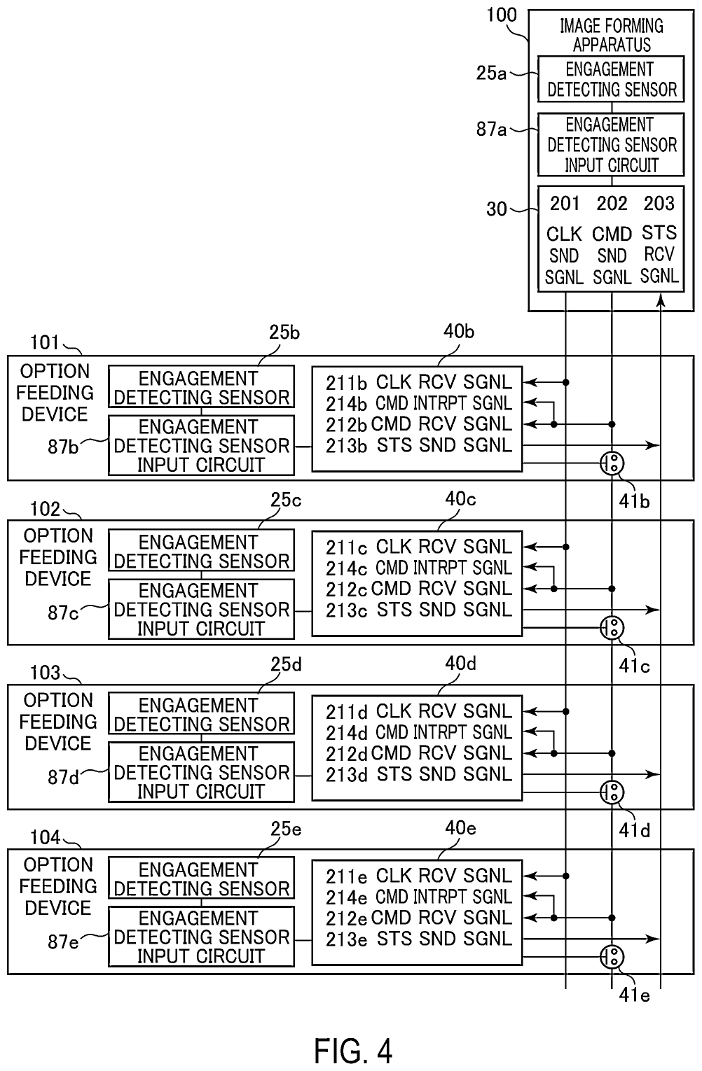

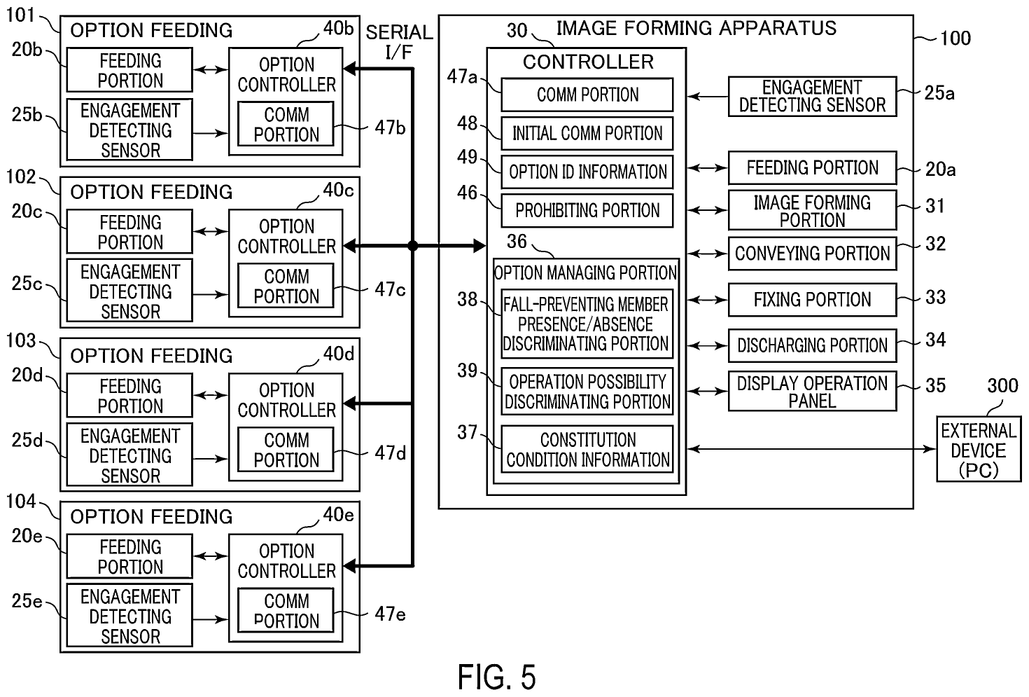

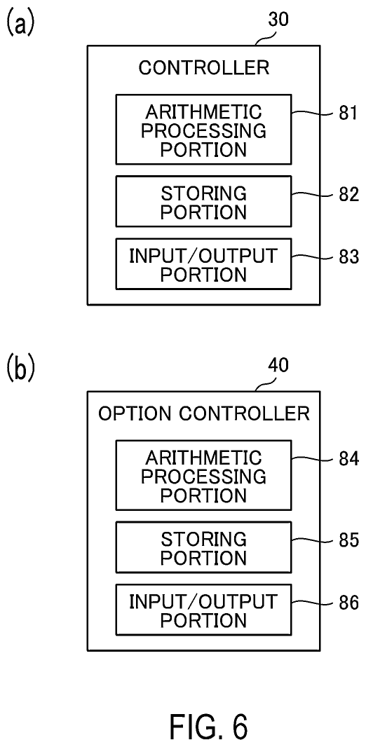

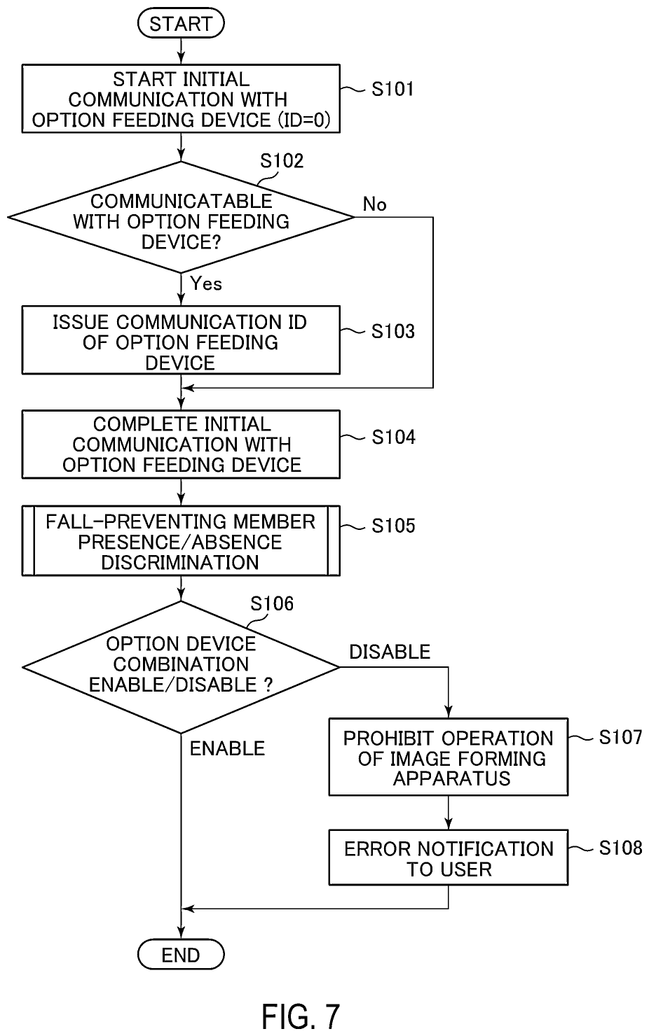

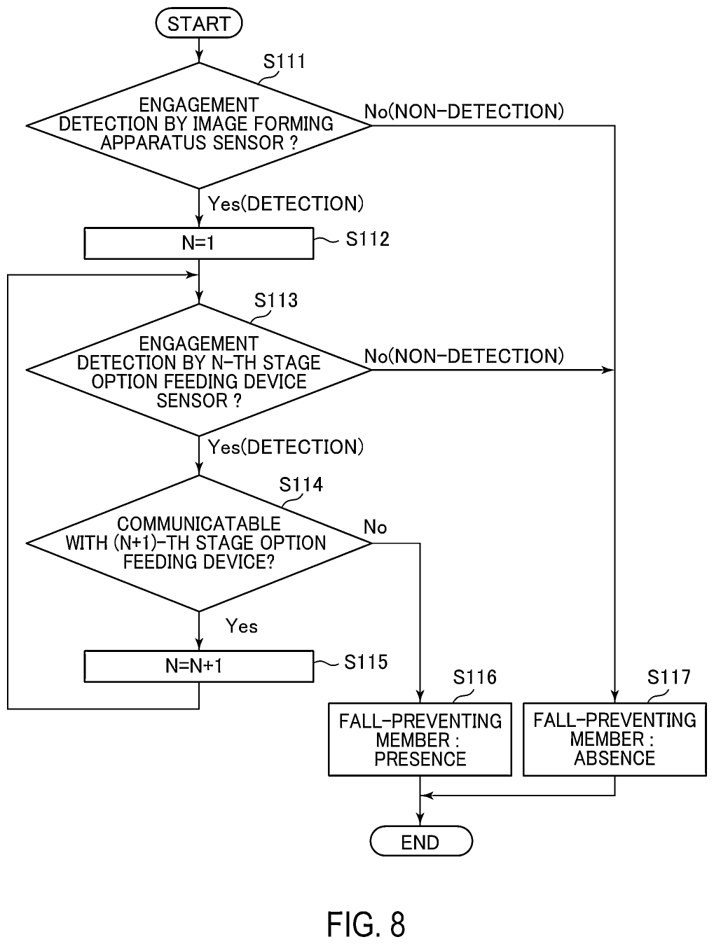

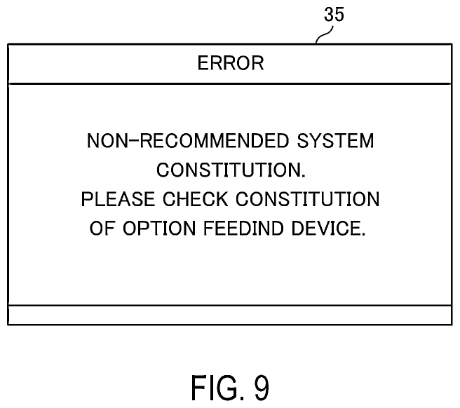

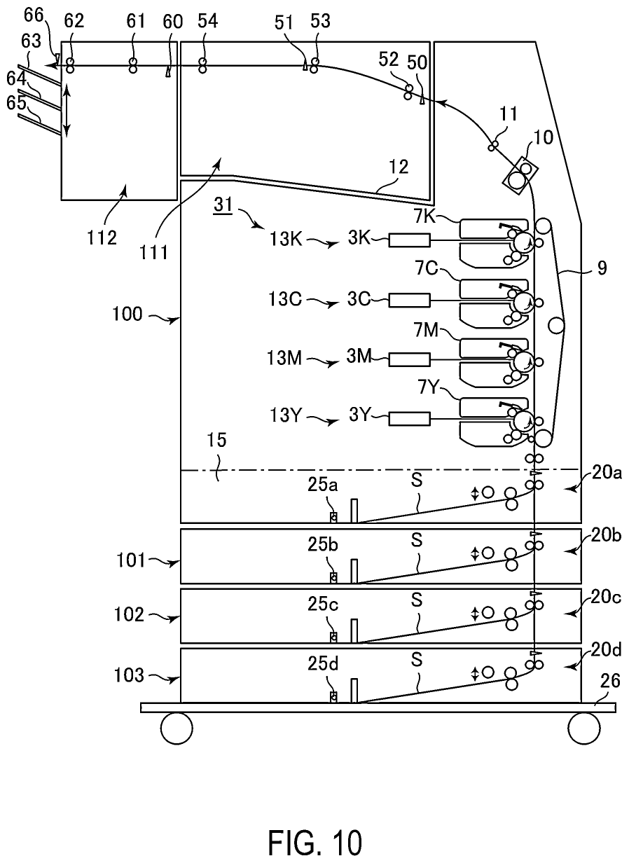

FIG. 1 is a schematic sectional view of an image forming system of this embodiment. In the embodiment of FIG. 1, the image forming system 200 is constituted by connecting four option feeding devices 101, 102, 103, and 104 and a fall-preventing member 26 to an image forming apparatus 100 so as to be detachably mountable to the image forming apparatus 100. Incidentally, as regards the image forming system 200 and elements thereof, an up-down direction refers to up and down in gravitational direction (vertical direction), but does not mean only immediately above and immediately below, and includes an upper side and a lower side of a horizontal plane passing through an element or a position of interest.

In this embodiment, the image forming apparatus (image forming apparatus main assembly) 100 is a tandem-type laser beam printer capable of forming a full-color image with use of an electrophotographic type. The image forming apparatus includes an image forming portion 31 and a feeding device 15 for feeding a sheet S to the image forming portion 31 is provided with as a plurality of image forming units, four image forming units 13Y, 13M, 13C, and 13K for forming images of yellow (M), magenta (M), cyan (C), and black (K), respectively. Incidentally, elements provided for the colors of Y, M, C, and K and having the same or corresponding functions or constitutions are collectively described in some instances by omitting suffixes Y, M, C, and K indicating the elements provided for associated colors, respectively. In this embodiment, the image forming unit 13 is constituted by including a photosensitive member 1 (1Y, 1M, 1C, 1K), a charging roller 2 (2Y, 2M, 2C, 2K), an exposure device 3 (3Y, 3M, 3C, 3K), a developing device 4 (4Y, 4M, 4C, 4K), a cleaning device 6 (6Y, 6M, 6C, 5K), and the like.

During image formation, a rotatable drum-shaped (cylindrical) photosensitive member (photosensitive drum) 1 is rotationally driven in a counterclockwise direction in FIG. 1. A surface of the rotating photosensitive member 1 is electrically charged uniformly by the charging roller 2 which is a roller-shaped charging member as a charging means. A charged surface of the photosensitive member 1 is irradiated with a laser beam by the exposure device (laser scanner) 3 as an exposure means on the basis of image information, so that an electrostatic latent image (electrostatic image) is formed on the photosensitive member 1. The electrostatic latent image formed on the photosensitive member 1 is developed (visualized) by being supplied with toner as a developer by the developing device 4 as the developing means, so that a toner image (toner picture developer image) is formed on the photosensitive member 1.

Opposite to the four photosensitive members 1Y, 1M, 1C, and 1K, a conveyance belt 9 which is a recording material carrying member constituted by an endless belt as a conveying means is provided. The conveyance belt 9 is stretched by a plurality of stretching rollers 9a, 9b, and 9c. To the conveyance belt 9, a driving force is transmitted by rotationally driving a driving roller which is one of the plurality of stretching rollers 9a, 9b, and 9c, so that the conveyance belt 9 is rotated (circulated and moved) in a clockwise direction in FIG. 1. On an inner peripheral surface side of the conveyance belt 9, opposite to the photosensitive members 1Y, 1M, 1C, and 1K, transfer rollers 5Y, 5M, 5C, and 5K which are roller-shaped transfer members as transfer means are provided, respectively. The transfer roller 5 is pressed toward the photosensitive member 1, and forms a transfer portion T where the photosensitive member 1 and the conveyance belt 9 are in contact with each other.

The toner image formed on the photosensitive member 1 is transferred onto a sheet (recording material, recording medium, transfer material) such as a recording sheet conveyed by the action of the transfer roller 5 so as to pass through the transfer portion T while being carried on the conveyance belt 9. For example, during full-color image formation, toner images of the colors of yellow, magenta, cyan, and black formed on the photosensitive members 1 are successively transferred onto the sheet S carried and conveyed by the conveyance belt 9, so that a multi-color image is formed on the sheet S.

Further, transfer residual toner remaining on the surface of the photosensitive member 1 after the transfer is removed and collected from the surface of the photosensitive member 1 by the cleaning device 6 as a cleaning means. The sheet S is fed from the feeding device 15 which is a feeding device provided in the image forming apparatus 100 or from the option feeding devices 101 to 104, which are feeding devices as option devices connected to the image forming apparatus 100, toward image forming portion 31. This sheet S is timed to formation of the toner image on the photosensitive member 1 by a registration roller pair 8, and then is conveyed toward the conveyance belt 9. Then, this sheet S is attracted to and carried on the conveyance belt 9 by the action of an attraction roller 9e as an attraction means.

The sheet S on which the toner image is transferred is separated from the conveyance belt 9 and is conveyed toward a fixing device 10 as a fixing means. The fixing device 10 is fixes (melts, sticks) the toner image on the sheet S by heating and pressing the sheet S on which an unfixed toner image is carried. The sheet S on which the toner image is fixed is discharged (outputted) onto a discharge tray 12 provided at an outside portion (upper portion) of the image forming apparatus 100 by a discharging roller pair 11 of a discharging portion.

Here, in this embodiment, the image forming portion 31 for forming the image on the sheet S is constituted by the image forming units 13Y, 13M, 13C, and 13K, the conveyance belt 9, and the transfer rollers 5Y, 5M, 5C, and 5K, and the like. Further, in this embodiment, in each of the image forming units 13, the photosensitive member 1, the charging roller 2, the developing device 4, and the cleaning device 6 are integrally assembled into a cartridge, and thus constitute a process cartridge 7 (7Y, 7M, 7C, 7K).

### <Sheet Feeding>

Feeding of the sheet S will be further described. The embodiment device (sheet feeding device, cassette) 14 provided in the image forming apparatus 100 includes a sheet accommodating portion 28a for accommodating sheets S, and a feeding portion 20a for feeding the sheets S one by one from the sheet accommodating portion 28a. The feeding portion 20a is constituted by including a pick-up roller 21a and a separation conveying roller pair 22a which are as feeding members, a conveying roller pair 23a as a conveying member, a conveyance sensor 24a for detecting the sheet S, and the like. In the case where the sheet S is fed from the feeding device 15 and the image is formed on the sheet S, the sheets S are separated and fed one by one from the sheet accommodating portion 28a by the pick-up roller 21a and the separation conveying roller pair 22a. This sheet S is conveyed by the conveying roller pair 23a. Then, this sheet S is, as described above, conveyed toward the conveyance belt 9 by the registration roller pair 8. Further, the sheet S fed from the feeding device 15 is detected by the conveyance sensor 24a, and a result thereof is used for control of a timing of image formation or the like. Further, although omitted from illustration, the feeding device 15 is also provided with a sheet presence/absence sensor for detecting presence/absence of the sheet S in the sheet accommodating portion 28a.

Further, in the embodiment of FIG. 1, at a lower portion of the image forming apparatus 100, the option feeding devices 101 to 104 are successively connected and are stacked and additionally provided in a vertical (up-down) direction. In this embodiment, the four option feeding devices 101 to 104 of the same kind are connected and mounted to the image forming apparatus 100. First, description will be made by taking, as an example, the option feeding device 101 in a first stage (uppermost stage) directly connected to the lower portion of the image forming apparatus 100. Incidentally, as regards elements having the same or corresponding functions or constitutions as elements of the feeding device 15 in the option feeding device 101, as suffixes of reference numerals “b” is added in place of “a” in the feeding device 15. The option feeding device (option sheet feeding device, option cassette) 101 includes a sheet accommodating portion 28b for accommodating sheets S, and a feeding portion 20b for feeding the sheets S one by one from the sheet accommodating portion 28b. The feeding portion 20b is constituted by including a pick-up roller 21b and a separation conveying roller pair 22b which are as feeding members, a conveying roller pair 23b as a conveying member, a conveyance sensor 24b for detecting the sheet S, and the like. In the case where the sheet S is fed from the option feeding device 101 and the image is formed on the sheet S, the sheets S are separated and fed one by one from the sheet accommodating portion 28b by the pick-up roller 21b and the separation conveying roller pair 22b. This sheet S is conveyed by the conveying roller pair 23b of the option feeding device 101 and is further conveyed by the conveying roller pair 23a of the feeding device 15 provided in the image forming apparatus 100. Then, this sheet S is, as described above, conveyed toward the conveyance belt 9 by the registration roller pair 8. Further, the sheet S fed from the feeding device 15 is detected by the conveyance sensor 24b of the option feeding device 101 and the conveyance sensor 24a of the feeding device 15 provided in the image forming apparatus 100, and a result thereof is used for control of a timing of image formation or the like. Further, although omitted from illustration, the option feeding device 101 is also provided with a sheet presence/absence sensor for detecting presence/absence of the sheet S in the sheet accommodating portion 28b.

The option feeding devices 102 to 104 in a second stage to fourth stage (lowermost stage) substantially have the same constitution as the constitution of the option feeding device 101 in the above-described uppermost stage. Incidentally, as regards elements, in the option feeding devices 102 to 104, having the same or corresponding functions or constitutions as the elements of the option feeding device 101, “c”, “d”, and “e” are added, respectively, to suffixes of reference numerals, in place of “b” in the option feeding device 101. That is, the option feeding devices 102 to 104 include sheet accommodating portions 28c, 28d, and 28e and feeding portions 20c, 20d, and 20e, respectively. The feeding portions 20c, 20d, and 20e are constituted by including pick-up rollers 21c, 21d, and 21e, separation conveying rollers 22c, 22d, and 22e, conveying rollers 23c, 23d, and 23e, conveyance sensor 24c, 24d, and 24e, respectively, and the like. Further, each of the option feeding devices 102 to 104 is also provided with a sheet presence/absence sensor (not shown). Further, an operation in the case where the sheet S is fed from each of the option feeding devices 102 to 104 and the image is formed on the sheet S is similar to an operation in the case where the sheet S is fed from the option feeding device 101 and the image is formed on the sheet S. However, in the case where the sheet S is fed from either one of the option feeding devices 102 to 104, the sheet S is conveyed by an associated one of the conveying rollers 23c, 23d, and 23e, and in addition, is conveyed by the conveying roller provided on a side downstream of the associated conveying roller in a conveying direction of the sheet S. Similarly, in the case where the sheet S is fed from either one of the option feeding devices 102 to 104, the sheet S is detected by an associated one of the conveyance sensors 24c, 24d, and 24e, and in addition, is detected by the conveyance sensor provided on a side downstream of the associated conveyance sensor in the conveying direction of the sheet S.

### <Connection of Option Feeding Devices and Fall-Preventing Member>

As described above, in the embodiment of FIG. 1, to the lower portion of the image forming apparatus 100, the four option feeding devices 101 to 104 are connected, and to the lower portion of the option feeding device 104 in the lowermost stage, the fall-preventing member (base, seat) 26 is connected.

The image forming apparatus 100 includes a recessed portion 72a as an engaging portion engageable with the option feeding device 101 or the fall-preventing member 26 which are to be connected to the lower portion thereof. Further, the image forming apparatus 100 includes an engagement detecting sensor 25a as an engagement detecting means for detecting engagement of the recessed portion 72a with the option feeding device 101 or the fall-preventing member 26.

The option feeding device 101 includes a recessed portion 72v as an engaging portion engageable with another option feeding device 102 or the fall-preventing member 26 which are to be connected to the lower portion thereof. Further, the option feeding device 101 includes an engagement detecting sensor 25b as an engagement detecting means for detecting engagement of the recessed portion 72b with the another option feeding device 102 or the fall-preventing member 26. Further, the option feeding device 101 includes a projected portion 73b as a portion-to-be-engaged with which the recessed portion 72a of the image forming apparatus 100 above the projected portion 73b or a recessed portion (such as the recessed portion 72b of the option feeding device 101 in the uppermost stage relative to the option feeding device 102 in the second stage) of another option feeding device engages. As described above, the option feeding devices 102 to 104 substantially have the same constitution as the constitution of the option feeding device 101. That is, the option feeding devices 102 to 104 include recessed portions 72c, 72d, and 72e and engagement detecting sensors 25c, 25c, and 25e, and projected portions 73c, 73d, and 73e, respectively.

The fall-preventing member 26 is a floor surface placing member (installation member) for making the image forming system 200 hard to fall down by being connected to the image forming apparatus 100 directly or through the option feeding devices 101 to 104 than in the case where the fall-preventing member 26 is not connected. The fall-preventing member 26 may only be required to have a constitution such that the image forming system 200 is made hard to fall down as described above.

For example, the fall-preventing member 26 is a member having an installation floor area larger than an installation floor area of the image forming apparatus 100. Here, as regards the installation floor area, in the case where the image forming apparatus 100 and the fall-preventing member 26 are viewed from above, a region surrounded by a portion where each of the image forming apparatus 100 and the fall-preventing member 26 are installed on a floor surface is represented by an occupied area. The fall-preventing member 26 is typically constituted by including a continuous plate-like member as a whole. However, for example, the fall-preventing member 26 may be divided into four members including four corners, respectively, in the case where the image forming apparatus 100 is viewed from above. Further, the fall-preventing member 26 is not limited to the member having the installation floor area larger than the installation floor area of the image forming apparatus 100. The fall-preventing member 26 may also be a member having a weight such that a center of gravity of the image forming system 200 can be made sufficiently lower by being connected to the image forming apparatus 100 directly or through the option feeding devices 101 to 104 than in the case where the fall-preventing member 26 is not connected. The fall-preventing member 26 may be a member satisfying one of the above-described requirements of the installation floor area and the weight or a member satisfying both of the above-described factors. Further, the fall-preventing member 26 may include casters installed on the floor surface when a constitution in which the image forming system 200 is made hard to fall down as described above is employed. The caster is constituted by including a rotatable wheel, a pivot for turning the wheel, and a stopper for restricting at least one of rotation and turning of the wheel.

In this embodiment, the fall-preventing member 26 includes a fall-preventing plate 26a which is a rectangular plate-like member in plan view, and four casters 26b mounted in the neighborhood of four corners of a lower surface of the fall-preventing member 26. This fall-preventing member 26 is connected to the image forming apparatus 100, whereby the installation floor area of the image forming system 200 is made larger than the installation floor area in the case where the fall-preventing member 26 is not connected, and in addition, the center of gravity of the image forming system 200 is lowered, so that the image forming system 200 is made hard to fall down. Further, the fall-preventing member 26 includes a projected portion 73 as a portion-to-be-engaged with which the recessed portion 72a of the image forming apparatus above the fall-preventing member 26 or the recessed portion 72e of the option feeding device (the option feeding device) 104 in the lowermost stage in the case where the option feeding devices are stacked in multi-stages) above the fall-preventing member 26 engages.

Thus, in the embodiment of FIG. 1, the image forming system 200 includes an engaging mechanism 27a between the image forming apparatus 100 and the uppermost option feeding device 101 connected to the lower portion of the image forming apparatus 100. This engaging mechanism 27a is constituted by including the recessed portion 72a of the image forming apparatus 100 and the projected portion 73b of the option feeding device 101. Further, the image forming system 200 includes an engaging mechanism 27b between the option feeding device 101 and the another option feeding device 102 connected to the lower portion of the option feeding device 101. This engaging mechanism 27b is constituted by including the recessed portion 72b of the option feeding device 101 and the projected portion 73c of the another option feeding device 102. Similarly, the image forming system 200 includes an engaging mechanism 27c between the option feeding device 102 and another option feeding device 103 and an engaging mechanism 27d between the option feeding device 103 and another option feeding device 104. Further, the image forming system 200 includes an engaging mechanism 27e between the option feeding device 104 and the fall-preventing member 26 connected to the lower portion of the lower most option feeding device 104. This engaging mechanism 27e is constituted by including the recessed portion 72e of the option feeding device 104 and the projected portion 73f of the fall-preventing member 26.

Engagement of the option feeding devices 101 to 104 with the image forming apparatus 100 or with another one of the option feeding devices 101 to 104, and engagement of the fall-preventing member 26 with the image forming apparatus 100 or with the option feeding devices 101 to 104 will be further described.

Part (a) of FIG. 2 is a schematic top plan view of the option feeding devices 101 to 104, and part (b) of FIG. 2 is a schematic sectional view of the option feeding devices 101 to 104 in a position of d1 in part (a) of FIG. 2. Further, part (c) of FIG. 2 is a schematic top plan view of the fall-preventing member 26, and part (d) of FIG. 2 is a schematic sectional view of the fall-preventing member 26 in a position of d2 in part (c) of FIG. 2.

As shown in parts (a) and (b) of FIG. 2, the option feeding devices 101 to 104 includes, at lower portions thereof, the recessed portions 72b to 72e and drawer connectors 70b to 70e as electrical connecting portions. The recessed portions 72b to 72e of the option feeding devices 101 to 104 are mechanisms for being physically engaged with another option feeding device or the fall-preventing member 26, which is connected to a lower portion of the option feeding devices 101 to 104. Further, the option feeding devices 101 to 104 include the engagement detecting sensors 25b to 25e in the recessed portions 72b to 72e, respectively. In this embodiment, each of the engagement detecting sensors 25b to 25e is constituted by including a mechanical switch changed in output signal by being physical moved at least at a part thereof. The drawer connectors 70b to 70e of the option feeding devices 101 to 104 transmit and receive signals by being electrically connected to another option feeding device connected to a lower portion of the option feeding devices 101 to 104.

Further, the option feeding devices 101 to 104 include the projected portions 73b to 73e and the drawer connectors 71b and 71e as electrical connecting portions, respectively, at upper portions thereof. The projected portions 73b to 73e of the option feeding devices 101 to 104 are mechanisms for being physically engaged with the image forming apparatus 100 or another option feeding device, which is connected to an upper portion thereof. Further, the drawer connectors 71b to 71e of the option feeding devices 101 to 104 transmit and receive signals by being electrically connected to the image forming apparatus 100 or the another option feeding device, which is connected to the upper portion thereof.

Part (a) of FIG. 3 is a schematic sectional view for illustrating the engaging mechanism 27a in FIG. 1, and shows a state in which the image forming apparatus 100 and the option feeding device 101 in the uppermost stage are connected to each other.

As shown in part (a) of FIG. 3, the image forming apparatus 100 includes, at the lower surface thereof, the recessed portion 72a and the drawer connector 70a as the electrical connecting portion. The recessed portion 72a of the image forming apparatus 100 is a mechanism for being physically engaged with the option feeding device 101 or the fall-preventing member 26, which is connected to the lower portion of the image forming apparatus 100. Further, the image forming apparatus 100 includes the engagement detecting sensor 25a in the recessed portion 72a. In this embodiment, the engagement detecting sensor 25a is constituted by including a mechanical switch changed in output signal by being physically moved at least at a part thereof. The drawer connector 70a of the image forming apparatus 100 transmits and receives a signal by being electrically connected to the option feeding device connected to the lower portion of the image forming apparatus 100.

Then, as shown in part (a) of FIG. 3, when the projected portion 73b of the option feeding device 101 is inserted into the recessed portion 72a of the image forming apparatus 100, the engagement detecting sensor 25a in the recessed portion 72a is physically pressed by the projected portion 73b. By this, output logic of the engagement detecting sensor 25a is changed. Further, the recessed portion 72a and the projected portion 73b are engaged with each other, so that the drawer connector 70a of the image forming apparatus 100 and the drawer connector 71a of the option feeding device 101 are connected to each other. By this through the drawer connector 70a and the drawer connector 70b, transmission and reception of the signal are enabled between the image forming apparatus 100 and the option feeding device 101.

Part (b) of FIG. 3 is a schematic sectional view for illustrating the engaging mechanism 27b in FIG. 1 and shows a state in which the option feeding device 101 in the uppermost stage and the option feeding device 102 in the second stage are connected to each other. As shown in part (b) of FIG. 3, when the projected portion 73c of the option feeding device 102 is inserted into the recessed portion 72b of the option feeding device 101, the engagement detecting sensor 25b in the recessed portion 72b is physically pressed by the projected portion 73c. By this, output logic of the engagement detecting sensor 25b is changed. Further, the recessed portion 72b and the recessed portion 73c are engaged with each other, so that the drawer connector 70b of the option feeding device 101 and the drawer connector 71c of the option feeding device 102 are connected to each other. By this through the drawer connector 70b and the drawer connector 71c, transmission and reception of the signal are enabled between the image forming apparatus 100 and the option feeding device 102. As regards the engaging mechanisms 27c and 27d in FIG. 1, these mechanisms are similar to the engaging mechanism 27b and therefore will be omitted from description.

Part (c) of FIG. 3 is a schematic sectional view for illustrating the engaging mechanism 27e in FIG. 1 and shows a state in which the option feeding device 104 in the lowermost stage and the fall-preventing member 26 are connected to each other. As shown in part (c) of FIG. 3, when the projected portion 73f of the fall-preventing member 26 is inserted into the recessed portion 72e of the option feeding device 104, the engagement detecting sensor 25e in the recessed portion 72e is physically pressed by the projected portion 73f. By this, output logic of the engagement detecting sensor 25e is changed. The fall-preventing member 26 does not include the drawer connector and a microcontroller described later. For that reason, communication is not carried out between the image forming apparatus 100 and the fall-preventing member 26. Further, in the case where the fall-preventing member 26 is directly connected to the image forming apparatus 100, the recessed portion 72a of the image forming apparatus 100 and the projected portion 73f of the fall-preventing member 26 are engaged with each other. By this, the engagement detecting sensor 25a in the recessed portion 72a of the image forming apparatus 100 is pressed by the projected portion 73f, so that output logic of the engagement detecting sensor 25a is changed.

Incidentally, the engagement detecting sensors 25a to 25e are not limited to a sensor having a mechanical switch. The engagement detecting sensors 25a to 25e may only be required to have a constitution capable of detecting presence/absence of the engagement. For example, the engagement detecting sensors 25a to 25e may also be an optical detecting sensor which includes a light emitting portion and a light receiving portion and which is changed in output signal due to a change in presence/absence of light emitted from the light emitting portion and received by the light receiving portion and in light quantity of the light. Further, the engagement detecting sensors 25a to 25e may also be another arbitrary detecting means.

Further, in this embodiment, the above-described recessed portions 72a to 72e have the substantially same shape, and the above-described projected portions 73b to 73e have the substantially same shape. In this embodiment, each of the recessed portions 72a to 72e is constituted by a cylindrical hole, and each of the projected portions 73a to 73e is constituted by a cylindrical member. However, the engaging mechanism is not limited to that the engaging mechanism is constituted by the projected portion and the recessed portion as in this embodiment.

Further, each of the image forming apparatus 100 and the option feeding devices 101 to 104 may include a plurality of engaging portions (recessed portions), whereas each of the option feeding devices 101 to 104 and the fall-preventing member 26 may include a plurality of portions-to-be-engaged (projected portions). For example, as shown in parts (a) and (c) of FIG. 2, each of the option feeding devices 101 to 104 and the fall-preventing member 26 includes an associated one of the above-described projected portions 73b to 73f in the neighborhood of one of the four corners in the case where the associated option feeding device or the fall-preventing member is viewed from above. Further, each of the option feeding devices 101 to 104 and the fall-preventing member 26 includes an associated one of other projected portions 75b to 75f in the neighborhood of at least another one of the four corners. In this case, the image forming apparatus 100 and the option feeding devices 101 to 104 are provided with recessed portions corresponding to the above-described other projected portions 75b to 75f. By this, the image forming apparatus 100, the option feeding devices 101 to 104, and the fall-preventing member 26 can be more firmly connected to each other.

Further, arbitrary fixing means (screw, screw holes, bolts, nuts, and the like) for fixing the image forming apparatus 100, the option feeding devices 101 to 104, and the fall-preventing member 26 to each other may be further provided.

### <Control Constitution of Image Forming System>

FIG. 4 is a block diagram, showing an outline of a hardware constitution of the image forming system 200, for illustrating a control constitution of the image forming system 200 in this embodiment.

The image forming apparatus 100 includes a controller 30 constituted by a microcontroller, and an engagement detecting sensor input circuit 87a for inputting the output logic of the engagement detecting sensor 25a to an I/O port of the controller 30. Further, the option feeding devices 101 to 104 include option controllers 40b to 40e each constituted by the microcontroller, switches 41b to 41e, and engagement detecting sensor input circuits 87b to 87e each for inputting output logic of an associated one of the engagement detecting sensors 25b to 25e, respectively.

FIG. 5 is a block diagram, showing an outline of a functional constitution of the image forming system 200, for illustrating a control constitution of the image forming system 200 in this embodiment. With reference to FIGS. 4 and 5, the control constitution of the image forming system 200 will be further described.

The controller 30 of the image forming apparatus 100 is constituted by the microcontroller. The controller 30 receives print image data transmitted from an external device 300 such as a personal computer (PC) and transmits a state of the image forming apparatus 100 to the external device 300. The controller 30 includes a communicating portion 47a as a communicating means, an initial communicating portion 48 as an initial communicating means, an option ID information storing portion 49, a restricting portion 46 as a restricting means, and an option managing portion 36.

The communicating portion 47a communicates with devices directly or indirectly connected to the image forming apparatus 100. The initial communicating portion 48 establishes communication with the option feeding devices 101 to 104 during turning-on of a power source (during power supply start, during power source ON) of the image forming apparatus 100 (image forming system 200). The initial communicating portion 48 successively establish communication with the option feeding devices 101 to 104 and designates IDs (option device identifiers) for the option feeding devices 101 to 104 with which the communication is established. Then, the initial communicating portion 48 causes the option ID information storing portion 49 to store these pieces of ID information (option ID information).

The restricting portion 46 carries out control so that the image forming apparatus 100 does not form the image even when the restricting portion 46 receives an image forming instruction from the external device 300. Here, the present invention is not limited to that the restricting portion 46 prohibits all the operations of the image forming apparatus 100. The restricting portion 46 may only be required so that the restricting portion 46 prevents an occurrence of a risk of falling(-down) of the image forming system 200 by prompting an operator such as a user or a service person to check or recombine the constitution of the image forming system 200 by substantially disabling utilization of the image forming apparatus 100. From this viewpoint, the restricting portion 46 may only be required to prohibit at least the image formation (specifically the formation of the toner image on the photosensitive member 1) by the image forming apparatus 100. For that reason, even when the restricting portion 46 carries out control so as to restrict the image formation by the image forming apparatus 100 (and further to provide notification as described later), for example, an adjusting operation of the image forming apparatus 100, an operation of a fan, and the like may also be performed. The restricting portion 46 may also carry out control so as to restrict substantially all the operations (excluding turning-off (OFF) of the power source of the image forming apparatus 100) of the image forming apparatus 100.

The option managing portion 36 includes a fall-preventing member presence/absence discriminating portion 38 as a fall-preventing member presence/absence discriminating means (hereinafter, referred also simply to as a “presence/absence discriminating portion”), a constitution condition information storing portion 37, and an operation possibility (enabling/disabling) discriminating portion 39 as an operation possibility discriminating means. The presence/absence discriminating portion 38 discriminates whether or not the fall-preventing member is connected, on the basis of the number of the option feeding devices 101 to 104 with which the communication is established by the communicating portion 48, and logic information (detection result) of the engagement detecting sensors 25a to 25e. Incidentally, the presence/absence discriminating portion 38 (controller 30) acquires the logic information of the engagement detecting sensors 25a to 25e by the communicating portion 47a. In the constitution condition information storing portion 37, constitution condition information which is information on a combination condition of the option devices for permitting the image forming apparatus 100 to carry out the image formation is stored. In this embodiment, in the constitution condition information storing portion 37, as the constitution condition information, table data as shown in a table 1 is stored.

TABLE 1

| | NFPM*¹ | WFPM*² |
|---|---|---|
| NOAOFD*³ | 3 or less | 4 or less |

*¹“NFPM” is no fall-preventing member.
*²“WFPM” is with fall-preventing member.
*^{3“}NOAOFD” is the number of allowable option feeding devices.

The operation possibility discriminating portion 39 discriminates enabling/disabling of the operation of the image forming apparatus 100 on the basis of information on whether or not the option feeding devices 101 to 104 is capable of establishing communication with the image forming apparatus 100 by the initial communicating portion 48, a discrimination result of the presence/absence discriminating portion 38, and the constitution condition information stored in the constitution condition information storing portion 37.

Further, the image forming apparatus 100 includes a display operation panel 35 as a display operation means connected to the controller 30. The display operation panel 35 includes a display portion for displaying information by control of the controller 30, and an input portion for inputting information (signal) to the controller 30 in response to an operation by an operator. By this, the display operation panel 35 receives an operation from the operator and notifies the operator of a message. The display operation panel may be constituted by, for example, a touch panel.

Further, to the controller 30, the engagement detecting sensor 25a, the feeding portion 20a, the image forming portion 31, the conveying portion 32 (registration roller pair 8 and the like), the fixing portion 33 (fixing device 10 and the like), and the discharging portion 34 (discharging roller pair 11 and the like), which are provided in the image forming apparatus 100, are connected.

Each of the option controllers 40b to 40e of the option feeding devices 101 to 104 is constituted by the microcontroller. The option controllers 40b to 40e include communicating portions 47b to 47e, respectively, as communicating means. To the option controllers 40b to 40e, feeding portions 20b to 20e and engagement detecting sensors 25b to 25e are connected, respectively. The option controllers 40b to 40e communicate with the controller 30 through serial interfaces (I/Fs) by the communicating portions 47b to 47e. Together with this, the option controllers 40b to 40e control the feeding portions 20b to 20e, respectively, to perform feeding of the sheet S, so that the sheet S is moved to the image forming apparatus 100. Further, the option controllers 40b to 40e transmit pieces of information (signals) indicating detection results of the engagement detecting sensors 25b to 25e by the communicating portions 47b to 47e, respectively.

As shown in part (a) of FIG. 6, the microcontroller constituting the controller 30 is constituted by including an arithmetic processing portion 81, a storing portion 82, an input/output portion 83, and the like. The above-described communicating portion 47a is constituted by the input/output portion 83 and the like of the controller 30. Further, the initial communicating portion 48, the restricting portion 46, and the fall-preventing member presence/absence discriminating portion 38 and the operation possibility discriminating portion 39 of the option managing portion 36, which are described above are realized by executing a program, stored in the storing portion 82 of the controller 30, by the arithmetic processing portion 81 of the controller 30. Further, the above-described option ID information storing portion 49 and the constitution condition information storing portion 37 of the option managing portion 36 are realized by the storing portion 82 of the controller 30. As shown in part (b) of FIG. 6, a microcomputer constituting each of the option controllers 40b to 40e is constituted by including an arithmetic processing portion 84, a storing portion 85, an input/output portion 86, and the like. The above-described communicating portions 47b to 47e are realized by the input/output portions 86 and the like of the option controllers 40b to 40e, respectively.

Incidentally, the controller 30 and the option controllers 40b to 40e may be constituted by cooperation of a CPU and another ASIC or by the ASIC only. That is, herein, the controller 30 and the option controllers 40b to 40e are described as a main part of the processing in some instances, but the main part of the processing is not necessarily limited to the controller 30 and the option controllers 40b to 40e which are constituted by the microcontrollers in this embodiment.

### <Communication Interfaces Between Image Forming Apparatus and Option Feeding Devices>

With reference to FIG. 4, communication interfaces between the image forming apparatus 100 and the option feeding devices 101 to 104 will be described.

First, communication of the image forming apparatus 100 with the option feeding devices 101 to 104 by the communicating portions 47a to 47e will be described.

The controller 30 of the image forming apparatus 100 and the option controllers 40b to 40e of the option feeding devices 101 to 104 are cascade-connected (cascade/serial connection). Further, the controller 30 of the image forming apparatus 100 and the option controllers 40b to 40e of the option feeding devices 101 to 104 are configured to be capable of communicating with each other by a common serial communication line.

As regards an interface signal, as a clock signal for realizing synchronization for communication (hereinafter, this signal is also referred to as a “CLK signal” or the like), the controller 30 outputs a CLK sending (transmission) signal 201. On the other hand, to each of the option controllers 40b to 40e sides, the CLK sending signal 201 is inputted as an associated one of CLK receiving signals 211b to 211e.

Further, as a command signal sent from the image forming apparatus 100 to each of the option feeding devices 101 to 104 (hereinafter, this signal is also referred to as a “CMD signal” or the like), the controller 30 outputs a CMD sending signal 202. On the other hand, to each of the option controllers 40b to 40e sides, the CMD sending signal 202 is inputted as an associated one of CMD receiving signals 212b to 212e.

Further, as a status signal sent (replied) from each of the option feeding devices 101 to 104 to the image forming apparatus 100 (hereinafter, this signal is also referred to as an “STS signal” or the like), an STS receiving signal 203 is inputted to the controller 30 side. On the other hand, the option controllers 40b to 40e output STS sending signals 213b to 213e inputted as the STS signal 203 to the controller 30 side.

Each of the CMD receiving signals 212b to 212e is branched into two signals. One is command interruption signal (hereinafter, also referred to as a “CMD interruption signal”) 214b, 214c, 214d, or 214e. The other is the CMD receiving signal 212b, 212c, 212d, or 212e. The CMD interruption signals 214b to 214e are inputted to interruption ports of the option controllers 40b to 40e, respectively, and setting is made so that when each of these signals 214b to 214e becomes a Low level, interruption is caused to occur.

Next, initial communication by the initial communicating portion 48 during turning-on of a power source of the image forming apparatus 100 (image forming system 200) will be described.

Switches 41b to 41e are capable of switching communication connection states (connection or non-connection) of the option controllers 40b to 40e which are cascade-connected to each other. In the following, a method in which transmission and reception of the CMD signals are successively made between the controller 30 and the option controllers 40b to 40e while switching the switches 41b to 41e and in which individual IDs (option device identifiers) are imparted to the option feeding devices 101 to 104, respectively.

During the turning-on of the power source of the image forming apparatus 100, all the option feeding devices 101 to 104 are in a state in which IDs are unregistered (not set). In this case, the option controllers 40b to 40e of the option feeding devices 101 to 104 put the switches 41b to 41e in a non-connection state (OFF state) so that the CMD signals are not inputted. That is, in this case, all the switches 41b to 41e are in the non-connection state.

Here, the controller 30 (specifically, the initial communicating portion 48) of the image forming apparatus 100 sends a command for designating ID=1 in the form of the CMD signal. Only the option controller 40b of the option feeding device 101 in the uppermost stage cam receive this command. The option controllers 40c to 40e of the option feeding devices 102 to 104 in the second stage to the final (lowermost) stage cannot receive the command because all the switches 41b to 41e are in the non-connection state.

The option controller 40a of the option feeding device 101 in the uppermost stage stores ID=1 of the option feeding device 101 on reception of the designation command of ID=1 in the state in which the ID is unregistered (not set), and switches the state of the switch 41b to the connection state. Further, by the STS signal, the option controller 40b sends (replies), to the controller 30 of the image forming apparatus 100, to the effect that ID=1 is registered. The controller 30 of the image forming apparatus 100 causes the option ID information storing portion 49 to store the ID information.

When the controller 30 of the image forming apparatus 100 checks that the option feeding device 101 in the uppermost stage is registered, by the STS signal, and subsequently sends a command for designating ID=2. In the present states of the switches 41b to 41e, the state of the switch 41b of the option feeding device 101 in the uppermost stage is put in the connection state, so that the option controllers 40b and 40c of the option feeding devices 101 and 102 in the uppermost stage and the second stage can receive this command. The option controller 40b of the option feeding device 101 in the uppermost stage has already stored (set) the ID, and therefore disregards a new ID registration command. On the other hand, the option controller 40c of the option feeding device in the second stage received the ID=2 registration command in the state in which the ID is not registered, and therefore stores ID=2 of the option feeding device 102, and then switches the state of the switch 41c to the connection state. Then, by the STS signal, the option controller 40c sends (replies), to the controller 30 of the image forming apparatus 100, to the effect that ID=2 is registered. The controller 30 of the image forming apparatus 100 causes the option ID information storing portion 49 to store the ID information.

Subsequently, in a similar manner, the switches 41c and 41d of the option feeding devices 102 and 103 in the second stage and the third stage are successively put in the connection state. By this, ID=3 is registered in the option controller 41d of the option feeding device 103 in the third stage, and ID=4 is registered in the option controller 41e of the option feeding device 104 in the lowermost stage. Further, the controller 30 of the image forming apparatus 100 causes the option ID information storing portion 49 to store these pieces of ID information. Incidentally, the ID information of the option feeding device 104 in the final stage is registered, so that the switch 41e of the option feeding device 104 in the final stage is also put in the connection state.

### <System Constitution Discrimination>

Next, system constitution discrimination processing during the turning-on of the power source of the image forming system 200 in this embodiment will be described. FIG. 7 is a flowchart of this processing. Further, FIG. 8 is a flowchart of processing of S105 of FIG. 7. Incidentally, in this embodiment, the image forming system 200 has a system constitution shown in FIG. 1. Further, in the constitution condition information storing portion 37, the constitution condition information of the table 1 is stored.

When the power source of the image forming apparatus 100 is turned on (ON), the controller 30 (initial communicating portion 48) performs initial communication with the option feeding device 101 connected to the lower portion of the image forming apparatus 100 (S101). Next, the controller 30 (initial communicating portion 48) discriminates whether or not the controller 30 (initial communicating portion 48) is capable of communicating with the option feeding device 101 (S102). In the case where the controller 30 (initial communicating portion 48) cannot communicate with the option feeding device 101, the controller 30 (initial communicating portion 48 discriminates that the initial communication with the option feeding device is completed (S104). In this embodiment, the case where the option feeding device 101 is connected to the image forming apparatus 100 is taken as an example, and therefore, the controller 30 (initial communicating portion 48) can communicate with the option feeding device 101 in S102. In this case, the controller 30 (initial communicating portion 48) issues ID (ID=1) to the option feeding device 101 and causes the option ID information storing portion 49 to store the issued ID information (S103). In S103, the controller 30 (initial communicating portion 48) issues IDs (ID=1 to ID=4) to the option feeding devices 101 to 104, respectively, and causes the option ID information storing portion 49 to store the issued pieces of ID information. Then, the controller 30 (initial communicating portion 48) discriminates that the initial communication with the option feeding devices 101 to 104 is completed when the controller 30 (initial communicating portion 48) has completely issued the IDs to the option feeding devices 101 to 104 (S104). Next, the controller 30 (presence/absence discriminating portion 38) performs presence/absence discrimination processing of the fall-preventing member 26 (S105).

With reference to FIG. 8, the presence/absence discrimination processing of the fall-preventing member 26 in S105 of FIG. 7 will be described. First, the controller 30 (presence/absence discriminating portion 38) checks the output logic of the engagement detecting sensor 25a of the image forming apparatus 100, i.e., discriminates whether or not the engagement detecting sensor 25a detects engagement (S111). In the case where the controller 30 (presence/absence discriminating potion 38) discriminated in S111 that the engagement detecting sensor 25a detects engagement in the engaging mechanism 27a, the controller 30 (presence/absence discriminating portion 38) checks presence/absence of connection with the fall-preventing member 26 (S112 to S115). In this embodiment, the case where the option feeding device 101 is connected to the image forming apparatus 100 is taken as an example, and in S103 of FIG. 7, the IDs are issued to the option feeding devices 101 to 104. For that reason, the controller 30 (presence/absence discriminating portion 38) successively checks the presence/absence of the connection with the fall-preventing member 26 from the option feeding device 101 in the uppermost stage to the option feeding device 104 in the lowermost stage in the following manner on the assumption that the option feeding device 101 is connected to the image forming apparatus 100. First, the controller 30 (presence/absence discriminating portion 38) substitutes 1 for a variable N indicating a stage number of the option feeding devices as check objects (S112). Then, the controller 30 (presence/absence discriminating portion 38) checks output logic of the engagement detecting sensor of an N-th stage option feeding device, i.e., discriminates whether or not the engagement detecting sensor detects the engagement (S113). Now, N=1 is set, and therefore, the controller 30 (presence/absence discriminating potion 38) checks a logic value of the engagement detecting sensor 25b of the first stage (uppermost stage) option feeding device 101. That is, the controller 30 (presence/absence discriminating portion 38) sends a command signal to the option feeding device 101 by using the communicating portion 47a. Then, the option feeding device 101 returns, as a status signal, the logic value of the engagement detecting sensor 25b. In the case where the controller 30 (presence/absence discriminating portion 38) discriminated in S113 that the engagement detecting sensor 25a detects the engagement, the controller 30 (presence/absence discriminating portion 38) discriminates whether or not the controller 30 (presence/absence discriminating portion 38) is capable of communicating with an (N+1)-th stage, i.e., second stage option feeding device 102 (S114). In this embodiment, the controller 30 (presence/absence discriminating portion 38) discriminates as being communicatable with the second stage option feeding device 102 when the ID information of the second stage option feeding device 102 is present in the option ID information storing portion 49. Then, the controller 30 (presence/absence discriminating portion 38) adds 1 to the variable N indicating the number of stages of the option feeding devices as the check objects (S115).

The controller 30 (presence/absence discriminating portion 38) performs the following operation in the case where the engagement detecting sensor for the N-th option feeding device does not detect the engagement in S113. That is, in this case, a detection result thereof shows that no device is connected to the lower portion of the lowermost communicatable option feeding device, so that the controller 30 (presence/absence discriminating portion 38) discriminates that the fall-preventing member 26 is not connected to the lowermost communicatable option feeding device (S117).

Further, the controller 30 (presence/absence discriminating portion 38) performs the following operation in the case where communication with the (N+1)-th option feeding device is impossible in S114. That is, in this case, a result thereof shows that an element other than the option feeding device is connected to the lower portion of the N-th option feeding device. To the lower portion of the option feeding device, an option feeding device or the fall-preventing member 26 is connectable, so that in this case, the controller 30 (presence/absence discriminating portion 38) discriminates that the fall-preventing member 26 is connected to the N-th option feeding device (S116).

Further, the controller 30 (presence/absence discriminating portion 38) performs the following operation in the case where the engagement detecting sensor 25a for the image forming apparatus 100 does not detect engagement in S111. That is, in this case, a detection result thereof shows that the option feeding device and the fall-preventing member 26 are not connected to the image forming apparatus 100, so that the controller 30 (presence/absence discriminating portion 38) discriminates that the fall-preventing member 26 is not connected to the image forming apparatus 100 (S117).

Incidentally, in this embodiment, the presence/absence of the fall-preventing member 26 is discriminated after the initial communication with all the option feeding devices 101 to 104 is ended, but may also be discriminated while establishing the initial communication with all the option feeding devices 101 to 104. For example, the presence/absence of the fall-preventing member 26 can be discriminated in the following manner. Similarly as in this embodiment, the controller 30 successively establishes communication with from the option feeding device 101 close to the image forming apparatus 100 and switches the switches 41b to 41e. Then, in the case where the engagement detecting sensor 25a for the image forming apparatus 100 detects the engagement, the controller 30 tries communication with the first (stage) option feeding device 101, and in the case where the communication is established, the controller 30 checks output logic of the engagement detecting sensor 5a for the image forming apparatus 100. Then, in the case where the engagement detecting sensor 25b for the first option feeding device 101 detects engagement, the controller 30 tries communication with the second option feeding device 102. Subsequently, the controller 30 discriminates the presence/absence of the fall-preventing member 26 while successively establishing communication in a similar manner.

Further, in this embodiment, the presence/absence of the fall-preventing member 26 is discriminated after the initial communication with the option feeding devices 101 to 104 is ended. For that reason, at the time of a start of presence/absence discrimination processing, the number of the option feeding devices 101 to 104 provided to the image forming system 200 is known. Accordingly, the presence/absence of the fall-preventing member 26 may also be discriminated by checking only the output logic of the engagement detecting sensor 25e for the lowermost option feeding device 104.

Subsequently, processing on and after S106 of FIG. 7 will be described. When the presence/absence discrimination processing of the fall-preventing member 26 is ended in S105, the controller 30 (operation possibility discriminating portion 39) discriminates possibility of a combination of the option feeding devices (possibility of the operation of the image forming apparatus 100) by using the constitution condition information stored in the constitution condition information storing portion 37 (S106). In the constitution condition information storing portion 37, the constitution condition information of the table 1 is stored. Accordingly, in the case where for example, four option feeding devices are connected to the image forming apparatus 100 and the fall-preventing member 26 is connected to the option feeding device, the controller 30 (operation possibility discriminating portion 39) discriminates that the operation of the image forming apparatus 100 is possible. Further, in the case where for example, the four option feeding devices are connected to the image forming apparatus 100 but the fall-preventing member 26 is not connected to the option feeding device, the controller 30 (operation possibility discriminating portion 39) discriminates that the operation of the image forming apparatus 100 is not possible.

In the case where discrimination that the operation of the image forming apparatus 100 is not possible is made in S106, the controller 30 (restricting portion 46) carries out control so as to restrict various operations of the image forming apparatus 100 (S107). Specifically, the controller 30 (restricting portion 46) carries out control so that the image forming apparatus 100 does not perform the image forming operation even when the image forming apparatus 100 receives print image data from the external device 300.

Thus, when the fall-preventing member 26 is not connected to the image forming apparatus 100 in the case where the number of the option feeding devices connected to the image forming apparatus 100 is larger than a first threshold (3 in this embodiment), the controller 30 executes processing for restricting image formation by the image forming apparatus 100. Further, when the fall-preventing member 26 is connected to the image forming apparatus 100, in the case where the number of the option feeding devices connected to the image forming apparatus 100 is larger than a second threshold (4 in this embodiment), the controller 30 executes the above-described restricting processing. Typically, the first threshold is lower than the second threshold. However, the first threshold and the second threshold are not limited thereto, but can be appropriately set depending on constitutions of the image forming apparatus, the option feeding devices, and the fall-preventing member, or the like from the viewpoint of preventing an occurrence of risk of falling of the image forming system 200.

Further, in this embodiment, the controller 30 (restricting portion 46) carries out control so as to notify the operator of that the operation of the image forming apparatus 100 is restricted (S108). For example, as shown in FIG. 9, the controller 30 (restricting portion 46) is capable of causing the display operation panel 35 to display a message prompting the operator to check and recombine the constitution of the image forming system 200. For example, this display is made over a whole screen of the display operation panel 35, and keys for inputting various settings on the image formation and a start instruction of the image formation are prevented from being displayed, so that the controller 30 (restricting portion 46) may cause the operator so that the operator cannot perform these operations. Further, the controller 30 (restricting portion 46) may also send error information to the external device 300. Depending on this error information, the external device 300 can make display similar to the above-described display in a display portion thereof. Further, in the case where the image forming apparatus 100 is provided with a speaker function (sound producing portion), notification may be made by lighting, blinking, or the like of a warning lamp. Further, the notification may also be made by an arbitrary method other than these methods.

By the above-described control, the controller 30 can distinguish between the option feeding devices 101 to 104 and the fall-preventing member 26. Further, in the case of a system constitution in which there is a falling risk of the image forming system 200, the controller 30 can prompt the operator to check and recombine the constitution of the image forming system 200 by restricting the operation of the image forming apparatus 100.

An image forming system 200 includes the image forming apparatus 100 or forming the image on a sheets, and the option feeding device 101 connected to the lower portion of the image forming apparatus 100 and for feeding the sheet S to the image forming apparatus 100, wherein to the lower portion of the option feeding device 101, another option feeding device 102 is connectable so that the plurality of option feeding devices 101 to 104 are stacked in the vertical direction and are connectable, and wherein the installation member (fall-preventing member) 26 to be installed on the floor surface is connectable to the lower portion of the option feeding devices 101 to 104. Further, in this embodiment, the image forming system 200 includes the controller 30 or controlling the operation of the image forming apparatus 100, the communicating means (communicating portion) 47a for transmitting and receiving the signals (data such as CMD signal, STS signal) between the image forming apparatus 100 and the option feeding devices 101 to 104, the engaging portion (recessed portion) 72b provided to the option feeding device 101 and engaging with the another option feeding device 102 to be connected to the lower portion of the option feeding device 101 or with the installation member 26, and the engagement detecting means (engagement detecting sensor) 25b provided to the option feeding device 101 and for detecting engagement of the engaging portion 72b with the another option feeding device 102 to be connected to the lower portion of the option feeding device 101 or with the installation member 26, wherein on the basis of the communication result by the communicating means 47a and the detection result by the engagement detecting means 25b, the controller 30 acquires first information on whether or not the installation member 26 is connected to the image forming apparatus 100, wherein on the basis of the communication result by the communicating means 47a, the controller 30 acquires second information on the number of the option feeding devices 101 to 104 connected to the image forming apparatus 100, and wherein on the basis of the first information and the second information, the controller 30 is capable of executing restricting processing for restricting the image formation by the image forming apparatus 100. In this embodiment, in the case where the controller 30 executes the restricting processing, the controller 30 executes processing for notifying information on the restricting processing. In this embodiment, in the case where engagement of the engaging portion 72b of the option feeding device 101 with a lower portion element which is either one of the another option feeding device 102 and the installation member 26 is detected by the engagement detecting means 25b of the option feeding device 101, when the controller 30 is incapable of communicating with the lower portion element by the communicating means 47a, the controller 30 discriminates that the installation member 26 is connected to the lower portion of the option feeding device 101, and when the controller is capable of communicating with the lower portion element by the communicating means 47a, the controller 30 discriminates that the another option feeding device 102 is connected to the lower portion of the option feeding device 101.

Further, in this embodiment, the image forming system 200 includes the engaging portion (recessed portion) 72a provided to the image forming apparatus 100 and engaging with the option feeding device 101 connected to the lower portion of the image forming apparatus 100 or with the installation member 26, and the engagement detecting means 25a provided to the image forming apparatus 100 and for detecting engagement of the engaging portion 72a of the image forming apparatus 100 with the option feeding device 101 or the installation member 26.

In this embodiment, the engaging portions 72a to 72e are recessed portions engaging with the projected portions 73b to 73f provided to the option feeding devices 101 to 104 or the installation member 26, and wherein the engagement detecting means 25a to 25e include sensors provided in the recessed portions and for detecting engagement between the recessed portions and the projected portions. Further, in this embodiment, the installation member 26 is provided with a plate-like member (fall-preventing plate) 26a having an installation floor area larger than an installation floor area of the image forming apparatus 100.

As described above, according to this embodiment, through the plurality of option feeding devices 101 to 104 capable of being additionally provided and connected to the image forming apparatus 100, connection or non-connection of the fall-preventing member (base seat) 26 is detected, so that it is possible to discriminate the possibility of the operation of the image forming apparatus 100. For that reason, there is no need to prepare the plurality of option feeding devices capable of being additionally provided and connected to the image forming apparatus and a floor-installed option feeding device for preventing falling, each provided with an electric contact and a microprocessor. By this, it is possible to suppress costs required for development, manufacturing, and the like of the image forming system 200. Further, according to this embodiment, by utilizing the constitution (projected portion, recessed portion) for engaging the option feeding devices 101 to 104 and the fall-preventing member 26, it is possible to detect the connection or the non-connection of the fall-preventing member 26. For that reason, there is no need to provide the option feeding devices 101 to 104 and the fall-preventing member 26 with a dedicated constitution for discriminating the presence/absence of the fall-preventing member 26.

Accordingly, according to this embodiment, with a constitution advantageous for cost reduction, the presence/absence of the fall-preventing member 26 is discriminated, and on the basis of a result thereof, it is possible to restrict the image formation of the image forming apparatus 100 depending on a system constitution. By this, the check and the recombination of the constitution of the image forming system 200 are prompted to the operator, so that it is possible to prevent the occurrence of the risk of falling the image forming system 200.

### Embodiment 2

Next, another embodiment of the present invention will be described. Basic constitution and operation of an image forming system of this embodiment are the same as those of the image forming system of the embodiment 1. Accordingly, elements having the same or corresponding functions or constitutions to those of the image forming system of the embodiment 1 will be omitted from detailed description by adding thereto the same reference numerals or symbols as those in the embodiment 1.

In the embodiment 1, the image forming system 200 was constituted by connecting the option feeding devices 101 to 104 and the fall-preventing member 26 to the image forming apparatus 100 in a detachably mountable manner. On the other hand, in this embodiment, an image forming system 200 is constituted by further connecting, to the image forming apparatus 100, an option device acting on the sheet S after the image formation in a detachably mountable manner.

FIG. 10 is a schematic sectional view of the image forming system 200 of this embodiment. In an example of FIG. 10, the image forming system 200 is constituted by connecting, to the image forming apparatus 100, three option feeding devices 101 to 103, an option intermediary conveying device 111, an option discharging device (option sheet (paper) discharging device) 112, and a fall-preventing member 26. The option intermediary conveying device 111 is connected to the image forming apparatus 100 so as to be positioned on a discharge tray 12 provided at an upper portion of the image forming apparatus 100. Further, the option discharging device 112 is connected to the image forming apparatus 100 in a state in which the option discharging device 112 is connected to the option intermediary conveying device 111 so as to be positioned on an outside of the image forming apparatus 100 when the image forming apparatus 100 is viewed from above.

The option intermediary conveying device 111 is the option device which receives the sheet S from the image forming apparatus 100 and which delivers the sheet S to the option discharging device 112. The option intermediary conveying device 111 is constituted by including conveying rollers 52, 53, and 54 as conveying members, conveying sensors 50 and 51, and the like.

The option discharging device 112 is the option provided which receives the sheet S from the option intermediary conveying device 111 and which discharges the sheet S to an outside of the image forming system 200. The option discharging device 112 includes a plurality of discharge bins 63, 64, and 65. The option discharging device 112 receives the sheet S from the option intermediary conveying device 111 and discharges the sheet S to either one of the plurality of discharge bins 63, 64, and 65. Further, the option discharging device 112 is constituted by including conveying rollers 61 and 62, conveying sensors 60 and 66, and the like.

The image forming apparatus 100 is connected to the option intermediary conveying device 111 and the option discharging device 112 by hardware signals through electrical connecting portions. By this, the controller 30 of the image forming apparatus 100 discriminates connection to each of the option intermediary conveying device 111 and the option discharging device 112 and provides an instruction of a timing of each processing to each of the option intermediary conveying device 111 and the option discharging device 112.

### <System Constitution Discrimination>

In this embodiment, in addition to the constitution of the image forming system 200, the option intermediary conveying device 111 and the option discharging device 112 are connected to the image forming apparatus 100. By this, a position of gravity of the image forming system 200 is different from (higher than) the position of gravity of the image forming system 200 of the embodiment 1. Accordingly, in this embodiment, there is a need to discriminate possibility of the operation of the image forming apparatus 100 including the option intermediary conveying device 111 and the option discharging device 112.

For that reason, in this embodiment, in the constitution condition information storing portion 37, constitution condition information to which information on the option intermediary conveying device 111 and the option discharging device 112 is added is stored. In this embodiment, in the constitution condition information storing portion 37, as the constitution condition information, table data as shown in a table 2 below is stored. Incidentally, the option intermediary conveying device 111 is the option device for sending the sheet S to the option discharging device 112. For that reason, as shown in the table 2, in the case where only either one of the option intermediary conveying device 111 and the option discharging device 112 is connected to the image forming apparatus 100, the operation of the image forming apparatus 100 is not possible (inoperable).

TABLE 2

| ODD*¹ | OICD*² | NFPM*³ | WFPM*⁴ |
|---|---|---|---|
| NO | NO | N*⁵: 3 or less | N*⁵: 4 or less |
| NO | YES | INOPERABLE | INOPERABLE |
| YES | NO | INOPERABLE | INOPERABLE |
| YES | YES | INOPERABLE | N*⁵: 3 or less |

*¹“ODD” is the option discharging device.
*²“OICD” is the option intermediary conveying device.
*³“NFPM” is no fall-preventing member (absence of the fall-preventing member).
*⁴“WFPM” is with fall-preventing member (presence of the fall-preventing member).
*⁵“N” is the number of allowable option feeding devices.

Procedure of system constitution discrimination processing at the time of turning-on of a power source of the image forming system 200 in this embodiment is similar to the procedure of the flowcharts of FIG. 7 and FIG. 8 described in the embodiment 1. However, in this embodiment, in S106 of FIG. 7, the controller 30 (operation possibility discriminating portion 39) discriminates possibility of the combination of the option devices (possibility of the operation of the image forming apparatus 100) by using the constitution condition information shown in the table 2 stored in the constitution condition information storing portion 37. That is, in this embodiment, the possibility of the combination of the option provides (possibility of the operation of the image forming apparatus 100) is discriminated including a connection status of the option intermediary conveying device 111 and the option discharging device 112 to the image forming apparatus 100. In this embodiment, the image forming apparatus 100 is connected to the option intermediary conveying device 111 and the option discharging device 112 by hardware signals through electrical connecting portions.

For that reason, the controller 30 (operation possibility discriminating portion 39) can discriminate the connection status of the option intermediary conveying device 111 and the option discharging device 112 on the basis of output logic of the hardware signals.

Thus, in this embodiment, to the image forming apparatus 100, the option device 112 different from the option feeding devices 101 to 104 is further connectable, and the controller 30 is capable of executing processing for restricting image formation by the image forming apparatus 100, on the basis of first information on whether or not the installation member (fall-preventing member) 26 is connected to the image forming apparatus 100, second information on the number of the option feeding devices 101 to 104 connected to the image forming apparatus 100, and third information on whether or not the above-described option device 112 is connected to the image forming apparatus 100. In this embodiment, the above-described option device 112 is a device (option discharging device) for receiving the sheet S discharged from the image forming apparatus 100 and for conveying the sheet S toward the outside of the image forming system 200.

Incidentally, in the constitution of the image forming system 200 of this embodiment shown in FIG. 10, the image forming apparatus 100 is provided with the engagement detecting sensor 25a. However, the image forming system 200 may have a constitution in which the image forming apparatus 100 is not provided with the engagement detecting sensor 25a. In the constitution in which the image forming apparatus 100 is not provided with the engagement detecting sensor 25a, in the case where no option feeding devices 101 to 104 is connected to the image forming apparatus 100, the controller 30 cannot discriminate whether or not the fall-preventing member 26 is connected to the image forming apparatus 100. In this case, for example, in S106 of FIG. 7, the controller 30 makes reference to both a discriminating condition of an allowable system constitution in the case where the fall-preventing member 26 is absent and a discriminating condition of an allowable system constitution in the case where the fall-preventing member 26 is present. Further, when the operation of the image forming apparatus 100 is not possible in either one of the discriminating conditions, the controller 30 can discriminate that the operation of the image forming apparatus 100 is not possible. For example, in the case where any of the option feeding devices 101 to 104, the option intermediary conveying device 111, and the option discharging device 112 are not connected to the image forming apparatus 100, from the constitution condition information of the table 2, irrespective of the presence/absence of the fall-preventing member 26, the controller 30 discriminates that the operation of the image forming apparatus 100 is possible. Further, in the case where the option feeding devices 101 to 104 are not connected to the image forming apparatus 100 and both the option intermediary conveying device 111 and the option discharging device 112 are connected to the image forming apparatus 100, from the constitution condition information of the table 2, the controller 30 discriminates that when the fall-preventing member 26 is absent, the operation of the image forming apparatus 100 is not possible. Further, even when the fall-preventing member 26 is connected, the controller 30 discriminates that the operation of the image forming apparatus 100 is not possible.

Further, in this embodiment, as shown in the table 2, in the case where the option intermediary conveying device 111 and the option discharging device 112 are connected to the image forming apparatus 100, when the fall-preventing member 26 is absent, the operation of the image forming apparatus 100 is not possible. However, the present invention is not limited thereto. When the risk of falling of the image forming system 200 is sufficiently low, in this case, for example, the number of allowable option feeding devices may also be changed to two or less (the number smaller than the number in the case where the fall-preventing member 26 is present).

Further, in this embodiment, as shown in the table 2, depending on the presence/absence of the option intermediary conveying device 111 and the option discharging device 112, each of the number of allowable option feeding devices when the fall-preventing member 26 is absent and the number of allowable option feeding devices when the fall-preventing member 26 is present is different. However, the present invention is not limited thereto. Depending on the constitution or the like of the option intermediary conveying device 111 and the option discharging device 112 between these devices are present and absent, at least one of the number of allowable option feeding devices when the fall-preventing member 26 is absent and the number of allowable option feeding devices when the fall-preventing member 26 is present may be the same.

Thus, when the fall-preventing member 26 is not connected to the image forming apparatus 100 and the option discharging device 112 is not connected to the image forming apparatus 100, in the case where the number of the option feeding devices connected to the image forming apparatus 100 is larger than a first threshold (3 in this embodiment), the controller 30 executes processing for restricting image formation by the image forming apparatus 100.

Thus, when the fall-preventing member 26 is connected to the image forming apparatus 100 but the option discharging device 112 is not connected to the image forming apparatus 100, in the case where the number of the option feeding devices connected to the image forming apparatus 100 is larger than the second threshold 43 in this embodiment), the controller 30 executes the above-described restricting processing. Further, when the fall-preventing member 26 is not connected to the image forming apparatus 100 but the option discharging device 112 is connected to the image forming apparatus 100, in the case where the number of the option feeding devices connected to the image forming apparatus 100 is larger than a third threshold (0 in this embodiment), the controller 30 executes the above-described restricting processing. Further, when the fall-preventing member 26 is connected to the image forming apparatus 100 and the option discharging device 112 is connected to the image forming apparatus 100, in the case where the number of the option feeding devices connected to the image forming apparatus 100 is larger than a fourth threshold (third in this embodiment), the controller 30 executes the above-described restricting processing. Typically, the first threshold is lower than the second threshold, the third threshold is lower than the fourth threshold, and the fourth threshold is the second threshold or less. However, the first to third thresholds are not limited thereto, but can be appropriately set depending on constitutions of the image forming apparatus, the option feeding devices, the option discharging device, and the fall-preventing member, or the like from the viewpoint of preventing an occurrence of risk of falling of the image forming system 200.

By the above-described control, even in the image forming system 200 in which the option device acting on the sheet S after the image formation, depending on the system constitution, it is possible to restrict the image formation of the image forming apparatus 100.

Incidentally, in this embodiment, as the example of the option device acting on the sheet S after the image formation, the option intermediary conveying device 111 and the option discharging device 112 were cited. However, the option device acting on the sheet S after the image formation is not limited to the above-described devices in this embodiment. For example, a constitution in which the option intermediary conveying device is not provided and in which the sheet S is delivered from the image forming apparatus to the option discharging device may also be employed. Further, for example, a constitution in which a plurality of option discharging devices 112 each provided with a single discharge bin can be connected to the image forming apparatus 100 may also be employed. Further, for example, a constitution in which a plurality of kinds of the option feeding devices different in function can be connected to the image forming apparatus may also be employed. In the constitution condition information storing portion 37, combination information on the classification and the number of option devices which are constituent elements of the image forming system 200 is stored.

Further, in this embodiment, the hardware signals are used for transmitting and receiving information between the image forming apparatus 100 and each of the option intermediary conveying device 111 and the option discharging device 112, but the present invention is not limited thereto. For example, the image forming apparatus 100 may transmit and receive the information by serial interface communication between itself and each of the option intermediary conveying device 111 and the option discharging device 112.

### Other Embodiments

In the above, the present invention was described in accordance with specific embodiments, but the present invention is not limited to the above-described embodiments.

In the above-described embodiments, the image forming system includes, as the image forming apparatus, the color image forming apparatus using the electrophotographic type, but the present invention is not limited thereto. The image forming apparatus may be an image forming apparatus of a type, such as an ink jet type, other than the electrophotographic type, and may also be a monochromatic image forming apparatus.

Further, in the embodiment 2, the option device different from the option feeding device was the option discharging device (and the option intermediary conveying device), but the present invention is not limited thereto, the option device different from the option feeding device may also be an image reader (image reading device), automatic original (document) feeding device (AFD), a finisher (post-processing device), and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-182879 filed on Oct. 24, 2023, which is hereby incorporated by reference herein in its entirety.

What is claimed is:

1. An image forming system comprising:
an image forming apparatus configured to form an image on a sheet;
an option feeding device connected to a lower portion of the image forming apparatus and configured to feed the sheet to the image forming apparatus, wherein to a lower portion of the option feeding device, another option feeding device is connectable so that a plurality of option feeding devices are stacked in a vertical direction and are connectable;
an installation member configured to be installed on a floor surface and connectable to a lower portion of the option feeding member;
a controller configured to control an operation of the image forming apparatus;
communicating means configured to transmit and receive a signal between the image forming apparatus and the option feeding device;
an engaging portion provided to the option feeding device and configured to engage with the another option feeding device to be connected to the lower portion of the option feeding device or with the installation member; and
engagement detecting means provided to the option feeding device and configured to detect engagement of the engaging portion with the another option feeding device to be connected to the lower portion of the option feeding device or with the installation member,
wherein on the basis of a communication result by the communicating means and a detection result by the engagement detecting means, the controller acquires first information on whether or not the installation member is connected to the image forming apparatus,
wherein on the basis of the communication result by the communicating means, the controller acquires second information on a number of the option feeding devices connected to the image forming apparatus, and
wherein on the basis of the first information and the second information, the controller is capable of executing restricting processing for restricting image formation by the image forming apparatus.

2. An image forming system according to claim 1, wherein in a case where the controller executes the restricting processing, the controller executes processing for notifying information on the restricting processing.

3. An image forming system according to claim 1, wherein in a case where engagement of the engaging portion of the option feeding device with a lower portion element which is either one of the another option feeding device and the installation member is detected by the engagement detecting means of the option feeding device,
when the controller is incapable of communicating with the lower portion element, the controller discriminates that the installation member is connected to the lower portion of the option feeding device, and
when the controller is capable of communicating with the lower portion element, the controller discriminates that the another option feeding device is connected to the lower portion of the option feeding device.

4. An image forming system according to claim 1, wherein when the installation member is not connected to the image forming apparatus, the controller executes the restricting processing in a case where the number of the option feeding devices connected to the image forming apparatus is larger than a first threshold, and
when the installation member is connected to the image forming apparatus, the controller executes the restricting processing in a case where the number of the option feeding devices connected to the image forming apparatus is larger than a second threshold.

5. An image forming system according to claim 4, wherein the first threshold is lower than a second threshold.

6. An image forming system according to claim 1, further comprising:
another engaging portion provided to the image forming apparatus and configured to engage with the option feeding device connected to the lower portion of the image forming apparatus or with the installation member; and
engagement detecting means provided to the image forming apparatus and configured to detect engagement of the another engaging portion of the image forming apparatus with the option feeding device or the installation member.

7. An image forming system according to claim 1, wherein to the image forming apparatus, an option device different from the option feeding device is connectable, and
wherein the controller is capable of executing the restricting processing on the basis of the first information, the second information, and third information on whether or not the option device is connected to the image forming apparatus.

8. An image forming system according to claim 7, wherein the option device is a device for receiving a sheet discharged from the image forming apparatus and for conveying the sheet toward an outside of the image forming system.

9. An image forming system according to claim 7, wherein when the installation member is not connected to the image forming apparatus and the option device is not connected to the image forming apparatus, the controller executes the restricting processing in a case where the number of the option feeding devices is higher than a first threshold,
wherein when the installation member is connected to the image forming apparatus and the option device is not connected to the image forming apparatus, the controller executes the restricting processing in a case where the number of the option feeding devices is higher than a second threshold,
wherein when the installation member is not connected to the image forming apparatus and the option device is connected to the image forming apparatus, the controller executes the restricting processing in a case where the number of the option feeding devices is higher than a third threshold,
wherein when the installation member is connected to the image forming apparatus and the option device is connected to the image forming apparatus, the controller executes the restricting processing in a case where the number of the option feeding devices is higher than a fourth threshold.

10. An image forming system according to claim 9, wherein the first threshold is lower than the second threshold, the third threshold is lower than the fourth threshold, and the fourth threshold is the second threshold or less.

11. An image forming system according to claim 1, wherein the engaging portion is a recessed portion engaging with the projected portion provided to the option feeding device or the installation member, and
wherein the engagement detecting means includes a sensor provided in the recessed portion and for detecting engagement between the recessed portion and the projected portion.

12. An image forming system according to claim 1, wherein the installation member is provided with a plate-like member having an installation floor area larger than an installation floor area of the image forming apparatus.
